(19) United States
(12) Patent Application Publication
(10) Pub. No.: US 2007/0194537 A1
(43) Pub. Date: Aug. 23, 2007

(54) Slide-ring gasket

(75) Inventors: Karl Lerchbaum, Steinweg (AT); Josef Liebmann, Sonnrain (AT); Ernst Stergar, Brucknergasse (AT)

Correspondence Address: CHAPMAN AND CUTLER, 111 WEST MONROE STREET, CHICAGO, IL, 60603, US

(73) Assignee: Voest-Alpine Bergtechnik Gesellschaft m.b.H, Zeltweg (AU)

(21) Appl. No.: 10/591,808

(22) PCT Filed: Mar. 9, 2005
(86) PCT No.: PCT/AT05/00084

§ 371 Date: Sep. 6, 2006

(30) Foreign Application Priority Data
Mar. 9, 2004 (AT) A 410/2004

(51) Int. Cl. F16J 15/34

(52) U.S. Cl. 277/404

(57) ABSTRACT

In a slide-ring gasket of stainless steel with a wear resistant coating (3) at the end planes (6) facing each other, the wear resistant coating (3) starting from the outer rim (3) of the slide-ring gasket extends in a radial direction only over an annular part section (5) of the end planes (6) facing each other.

The invention relates to a slide-ring gasket of stainless steel with a wear resistant coating on the end planes facing each other.

Slide-ring gaskets of the initial mentioned kind as a rule consist of a metallic carrier on which different materials as wear resistant layers are applied by means of different methods. From DE 19546825 A1 a slide-ring gasket can be seen in which the sliding-and/or counter-ring consists of metallic material and in which the end planes of the slide-and/or counter-ring facing each other are coated with a burned-in powder coating. In the DE 3014866 A1 the planes of the slide-ring facing each other are coated with a material of high hardness by plasma-ray-treatment, whereby a coating of metal-ceramic wolfram-carbide and of nickel containing material-is suggested.

Slide-ring gaskets usually are exchanged after attrition of the contact surfaces. However, already prior to such a complete attrition of the contact surfaces there is the risk that notches are formed on the periphery via which notches dust-and dirt-particles are sucked and transported inwards despite apparently still immaculate contact surfaces of the slide-ring gasket. Slide-ring gaskets as a rule are pressed together resiliently so that impermissible wear is as a rule perceived only when lubricant from the inside reaches the outer periphery of the slide-ring gaskets and there, under formation of droplets, becomes visible. As a rule, with increasing wear the effective sealing area as a rule moves together with the still intact wear reducing coating radially inwards so that a form of notch is formed in the areas lying radially outwards, which notch abets the sucking and transporting of dust-and dirt-particles to the inside.

The invention aims thus to provide the slide ring gasket of the initially mentioned kind with which impermissible wear is detected at a time at which the transport of dust- and dirt-particles to the inside of the compartments to be sealed can be ruled out with high accuracy.

To solve this object the inventive embodiment of the initially mentioned slide-ring gasket substantially consists therein, that the wear resistant coating starting from the outer rim of the slide-ring gasket extends in a radial direction only over an annular part section of the end planes facing each other. Thereby, that the wear resistant coating starting at the outer rim of the slide-ring gasket in a radial direction extends only over an annular part section of the end planes facing each other, it is safeguarded, that after wear of this outer part section or of the annular ring coated with the wear resistant coating respectively a leakage and a discharge of lubricant droplets immediately become visible already before dust- and dirt-particles can be transported into the inside of the compartment to be sealed via a respective notch. Thus, the formation of V-shaped notches on the outside or the outer periphery of the slide-ring gasket respectively is prevented in order to safeguard the signalling of wear at an early stage and in particular in time by the appearance of lubricant droplets at the outside or the outer periphery of the slide-ring gasket respectively.

In a particularly advantagous manner the embodiment is hereby devised such that the end planes facing each other are under cut in the area following the annular part section in a radial direction inwardly or are formed offset in an axial direction respectively so that in the case of sliding sealing a clearance is formed, whereby it is in this manner safeguarded that the wear resulting from friction is confined to the border areas being coated with the wear resistant coating or to the annulus lying outside respectively and that in this area over an adequately long period a plane bearing of the two sliding sealing surfaces is safeguarded. All this counteracts the transport of dust- and dirt-particles from the outside to the inside and at the respective wear of the annular slide surfaces immediately results in the transport of lubricant to the periphery.

Advantageously the slide-ring gasket is devised such that stainless steel of the type X20 Cr13 is applied as the basic material whereby the basic material is hardened and tempered to RM 800-950N/m².

The thickness of the coating can in a preferred manner be from 0,1 to 0,6 mm and in particular be 0,3 mm. The coating material can in a simple manner be applied by means of a powder-spray process.

For the initially mentioned timely premonition of an impermissibly high wear the embodiment is advantageously devised such that the radial width of the annular sealing faces is less than 30%, preferably less than 25%, of the radial reach of the end planes of the slide-ring gasket facing each other, whereby the radial width of the annular sealing face is advantageously chosen <5 mm and preferably <3 mm.

By the part sections radially inwardly following the slide-ring faces cooperating with each other being undercut or formed offset in an axial direction respectively a conical chamfer on the inner surfaces is also here prevented so that indeed immediately after impermissible high wear in the outer zones or in the mentioned annular part section respectively the impermissible wear is safely recognized.

The small radial sealing face can, after the application by means of a powder-spray process, be subjected to diamond grinding to provide high tightness.

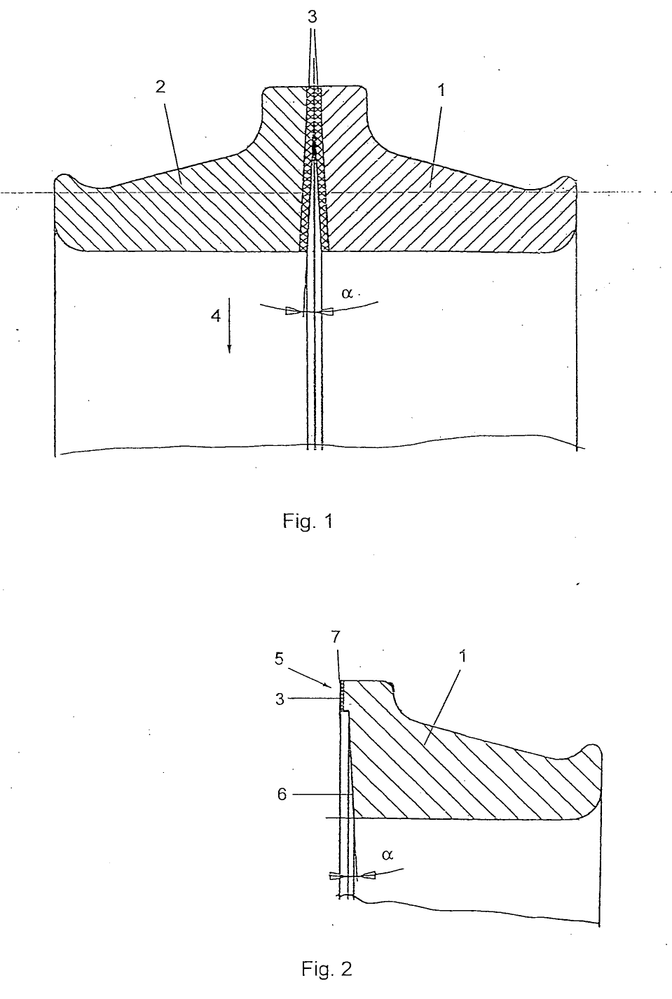

The invention will now be described in more detail by the exemplary embodiments schematically depicted in the drawings. In this FIG. 1 shows a first embodiment of a conventional slide-ring gasket and FIG. 2 shows the embodiment according to the invention in a sectional view.

In FIG. 1 a slide-ring 1 and a counter-ring 2 can be seen whose end planes facing each other are coated with a corrosion- and wear resistant coating 3. The rings are resiliently pressed against each other and they show radially inwards a gap with an angle a, which causes the active sealing surface to radially migrate from the outside to the inside in the direction of the arrow 4.

In the inventive embodiment according to FIG. 2 following the coating 3 extending only over an annular surface 5 the end plane 6 of the slide-ring 1 is formed offset. After wear of the wear resistant coating 3 in the outer annular part section 5 of the slide-ring 1 lubricant reaches the periphery via the offset part section 6 and hence attains to the circumference 7 at a moment at which the hazard of sucking and transporting inwards of dust or dirt is not yet present, as a respective V-shaped or conical chamfer respectively can not immerge in the part section protected by the wear resistant coating.

1. Slide-ring gasket of stainless steel comprising a wear resistant coating (3) at end planes (6) facing each other of the slide-ring gasket, wherein:
the wear resistant coating (3) extends from an outer rim of the slide-ring gasket inwardly in a radial direction only over an annular part section (5) of the end planes (6) facing each other;
the end planes (6) facing each other are undercut or formed offset in an axial direction respectively in an area following in a radial direction inwardly of the annular part section (5) so that with sliding sealing a clearance is formed; and
a radial width of annular sealing surfaces is less than 30% of a radial reach of the end planes (6) facing each other of the slide-ring gasket.

2. Slide-ring gasket according to claim 1, wherein the stainless steel is type X20 Cr13 stainless steel.

3. Slide-ring gasket according to claim 2, wherein the stainless steel is hardened and tempered to RM 800-950N/m².

4. Slide-ring gasket according to claim 1, wherein thickness of the coating (3) is from 0.1 to 0.6 mm.

5. Slide-ring gasket according to claim 1, wherein radial width of the annular sealing surfaces is less than 5 mm.

6. Slide-ring gasket according to claim 1, wherein the radial width of the annular sealing surfaces is less than 25% of the radial reach of the end planes (6) facing each other of the slide-ring gasket.

7. Slide-ring gasket according to claim 1, wherein thickness of the coating (3) is 0.3 mm.

8. Slide-ring gasket according to claim 2, wherein thickness of the coating (3) is from 0.1 to 0.6 mm.

9. Slide-ring gasket according to claim 3, wherein thickness of the coating (3) is from 0.1 to 0.6 mm.

10. Slide-ring gasket according to claim 2, wherein radial width of the annular sealing surfaces is less than 5 mm.

11. Slide-ring gasket according to claim 3, wherein radial width of the annular sealing surfaces is less than 5 mm.

12. Slide-ring gasket according to claim 4, wherein radial width of the annular sealing surfaces is less than 5 mm.

13. Slide-ring gasket according to claim 1, wherein radial width of the annular sealing surfaces is less than 3 mm.

14. Slide-ring gasket according to claim 2, wherein radial width of the annular sealing surfaces is less than 3 mm.

15. Slide-ring gasket according to claim 3, wherein radial width of the annular sealing surfaces is less than 3 mm.

16. Slide-ring gasket according to claim 4, wherein radial width of the annular sealing surfaces is less than 3 mm.
